(19) United States
(12) Patent Application Publication
(10) Pub. No.: US 2007/0269472 A1
(43) Pub. Date: Nov. 22, 2007

(54) Pest-control product

(76) Inventors: Osamu Igarashi, Yokohama-shi (JP); Chiyo Matsui, San Jose, CA (US); Toru Takahashi, Sagamihara-shi (JP)

Correspondence Address: CARR & FERRELL LLP, 2200 GENG ROAD, PALO ALTO, CA, 94303, US

(21) Appl. No.: 11/437,280

(22) Filed: May 18, 2006

(51) Int. Cl. A01N 25/00

(52) U.S. Cl. 424/405

(57) ABSTRACT

A pest-control product including a product body made of a resin containing at least either an insect-repelling agent or an insecticide. The product body can keep a plane spiral shape and change its shape to a three-dimensional helix. Even if the volume (or size) of the pest-control product is small, the pest-control product can be effective over an extensive area.

### BACKGROUND

1. Technical Field

The present invention relates to a pest-control product having the effect of controlling pests by repelling or killing them (hereinafter simply referred as the “pest-control effect”), the product being applied to target(s) that are to be protected against damage caused by the pests.

2. Related Art

It is common that outdoor electric equipment such as transformers and traffic signal controllers, outdoor machinery such as automobiles, motorcycles, and tractors, and houses sometimes become infested with or invaded by pests. In particular, if pests enter, nest and die in the electric equipment or similar, and dead pests accumulate in the electric equipment, electrical shorting or insulation may be unexpectedly caused in a control circuit, resulting in a failure of the equipment. Therefore, the electric equipment is inspected regularly and dead pests and nests are removed whenever they are found.

In the United States in particular, pests such as fire ants (red ants that live mainly in the United States) sometimes enter and nest in the electric equipment or similar. Afire ant bite will get swollen like a burn and cause severe pain and itching. Therefore, caution should be exercised upon regular inspection of electric equipment.

There are many other poisonous pests. There are poisonous arthropods such as spiders and centipedes, and poisonous insects (designated pests such as mosquitoes, flies, cockroaches, termites, mites, fleas, nematodes, and hornets). Accordingly, it is necessary to take appropriate measures to prevent pests from entering, for example, houses and machinery (such as automobiles, motorcycles, and tractors) people operate and often park outside.

Various defensive measures have been suggested to prevent the infestation of pests in equipment. For example, JP-A-3-10632 discloses a product made by placing and securing a pest control agent (or insecticide) held between two tape-shaped sheet base materials at specified spaced positions wherein one side of the tape sheet is adhesive so that the product can be attached to plants such as trees.

JP-A-2004-357553 suggests a pest-control product (or pest-repelling component) that prevents infestation of pests in electric equipment. This pest-control product is made of a resin containing a pest-control element. A plurality of wires connected to a connector for the electric equipment can be bundled together by winding the pest-control product around the wires to tie them in a bundle. Also, the pest-control product protects the electric equipment against pests entering the equipment via the wires by the effect of the pest-control element gradually released from the resin.

Moreover, JP-A-2003-199478 introduces a device that protects against bird and animal damage on various cables. An example of such a device that protects against bird and animal damage on cables is a belt-like sheet made by laminating elastic sheets, and a metallic protective member, wherein the belt-like sheet is wound around the cables or similar in a spiral fashion.

The pest-control product is made of a resin containing a pest-control element as described above. This pest-control is effective at and around the pest-control product. Accordingly, the area where the pest-control is effective is determined by the volume (or size) of the pest-control product. Consequently, in order for the pest-control effect to be effective over an extensive area, pest-control products are placed at certain intervals or the volume (or size) of the pest-control product is increased.

### SUMMARY

The present invention was devised in view of the circumstances described above. It is an object of the invention to provide a pest-control product capable being effective in an extensive area even if the volume (or size) of the pest-control product is small.

According to an aspect of the invention, in order to achieve the object of the invention, a pest-control product for exterminating pests, that includes a product body made of a resin containing at least either an insect-repelling agent or an insecticide is provided, wherein the product body is capable of keeping a plane spiral shape and changing its shape to a three-dimensional helix.

Since the pest-control product having the above-described configuration is made of a resin containing at least either the insect-repelling agent or the insecticide, it can be effective for pest control. Also, since the pest-control product can keep its plane spiral shape, it does not occupy lots of space, and is suitable for compact storage and convenient for portable use. Since the pest-control product can be packed in a minimum volume at the time of shipment (or delivery), it is possible to curb delivery costs. Furthermore, since this pest-control product can change its shape to a three-dimensional helix, even if the volume of the pest-control product itself is small, it can be made to cover an extensive area in three-dimensional space. Accordingly, the pest-control can be effective over an extensive area.

The pest-control product according to the invention may be the type of product that can be kept in the three-dimensional helix when supported at one or more locations on the helix. Alternatively, the pest-control product may be the type of product (so-called “shape memory type”) that can keep a desired three-dimensional helix shape once it is made into a helix, without application of any special force, for example, without being supported at different locations.

The product body can restore its shape from the three-dimensional helix to the plane spiral shape. If the pest-control product 1 is the type of product that can be kept as a three-dimensional helix when supported at one or more arbitrary locations, the pest-control product 1 can easily return to its original shape (plane spiral shape) simply by releasing the support(s).

Furthermore, if the product body is the shape memory type as described above, the shape of the product body can be further changed by applying a force to the product body. Once the product body changes its shape, it can keep that shape without any special force being applied.

In the pest-control product according to the invention, the product body may have at least one attachment part to attach the pest-control product to a target. Because of this configuration, the pest-control product can be easily attached to the target, while keeping its three-dimensional helix shape.

If the attachment part is provided on the product body, the attachment part can be formed as a hole made in the product body, and a thick part that is thicker than the thickness of the product body can be formed around the periphery of the hole. If the product body has a uniform thickness, the cross-sectional area of the part where the hole is made, as taken along the hole depth direction, becomes small. In this case, the thick part can supplement any cross-sectional area shortage.

Moreover, in the configuration described above, the product body may be made of one continuous belt member formed in a spiral shape, and the thickness of the thick part should preferably be set so that a cross-section of the belt member taken along the direction generally perpendicular to the longitudinal direction of the belt member is mostly uniform over the entire belt member from one end to the other end. In addition to the advantageous effects described above, this configuration makes it possible for the entire pest-control product to be uniformly effective.

The attachment parts can be formed at at least both ends of the product body.

Furthermore, the pest-control product according to the invention can be configured so that it includes two product bodies, and each product body is made of one continuous belt member; and when one of the product bodies is in a plane spiral shape, the other product body can be placed in a spiral space defined by the spiral shape. In addition to the advantageous effects described above, this configuration makes it possible to manufacture the pest-control product economically. If the spiral-shaped product body is manufactured by punching from one resin sheet containing at least either the insect-repelling agent or the insecticide, the spiral space defined by the above-mentioned spiral shape can be utilized as the product body for another pest-control product. Also, two pest-control products can be stored or carried around in almost the same space as that required for one pest-control product.

In the configuration described above, the spiral shape of the product body can be made complementary to the spiral space defined by the spiral shape.

There are no particular limitations on the contour of the product body in a spiral shape, and various shapes are possible such as generally circular, triangular, quadrangular, pentagonal, or polygonal (with six or more sides) shapes. However, a generally quadrangular shape is advantageous in terms of manufacturing, storage, and portable use.

### BRIEF DESCRIPTION OF THE DRAWINGS

FIG. 1 is a plan view of a pest-control product according to an embodiment of the invention.

FIG. 2 is a side view of the pest-control product in FIG. 1 as seen from the direction indicated by arrow X.

FIG. 3 is a perspective view of the pest-control product in FIG. 1 in a three-dimensional helix state.

FIG. 4 is a perspective view of the pest-control product in FIG. 3 in a more complicated three-dimensional helix state.

FIG. 5 is a schematic diagram showing an example of the state where the pest-control product in FIG. 4 is placed inside a transformer.

FIG. 6 is a schematic diagram showing another example of the state where the pest-control product in FIG. 4 is placed inside a transformer.

FIG. 7 is a perspective view of a fastening device used to place the pest-control product in FIG. 4 inside a transformer.

FIG. 8 is a cross-sectional view showing the state where the fastening device in FIG. 7 is secured to the inside wall of a transformer.

FIG. 9 is a cross-sectional view showing the fastening device in FIG. 7 in use.

FIG. 10 is a plan view of a pest-control product according to another embodiment of the invention.

FIG. 11 is a schematic diagram showing how to attach the pest-control product according to a further embodiment of the invention.

FIG. 12 is a plan view of a pest-control product according to a further embodiment of the invention.

FIG. 13 is a plan view of one of the product bodies in FIG. 12.

FIG. 14 is a plan view of the other product body in FIG. 12.

### DETAILED DESCRIPTION OF PREFERRED EMBODIMENTS

Pest-control products according to preferred embodiments of the invention will be described below with reference to the attached drawings. The embodiments described below are for the purpose of describing this invention, but the invention is not limited only to those embodiments. Accordingly, this invention can be utilized in various ways unless those utilizations depart from the gist of the invention.

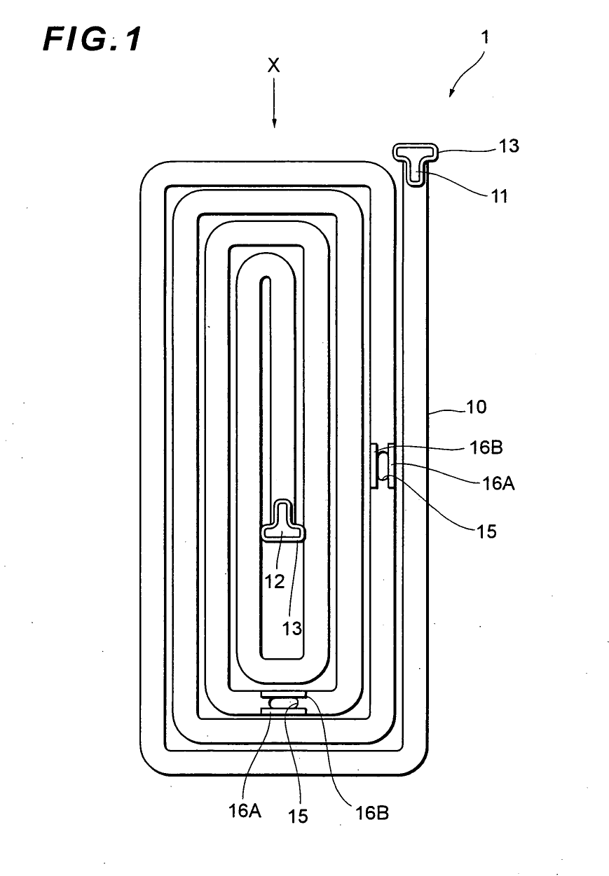

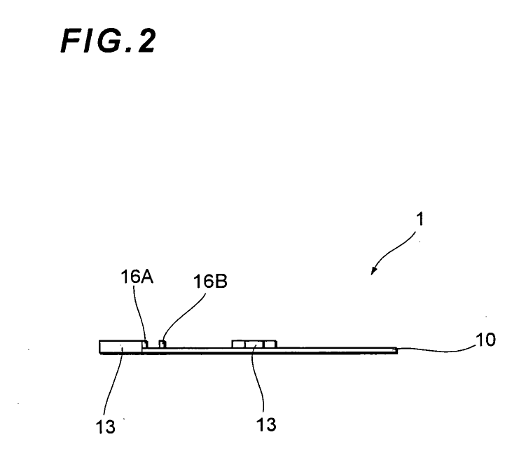

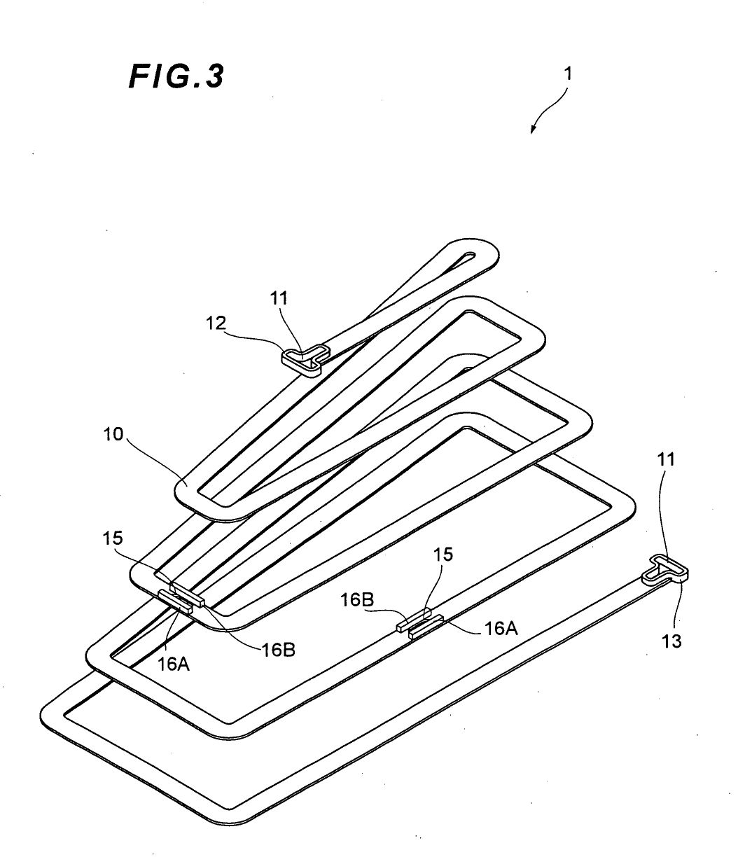

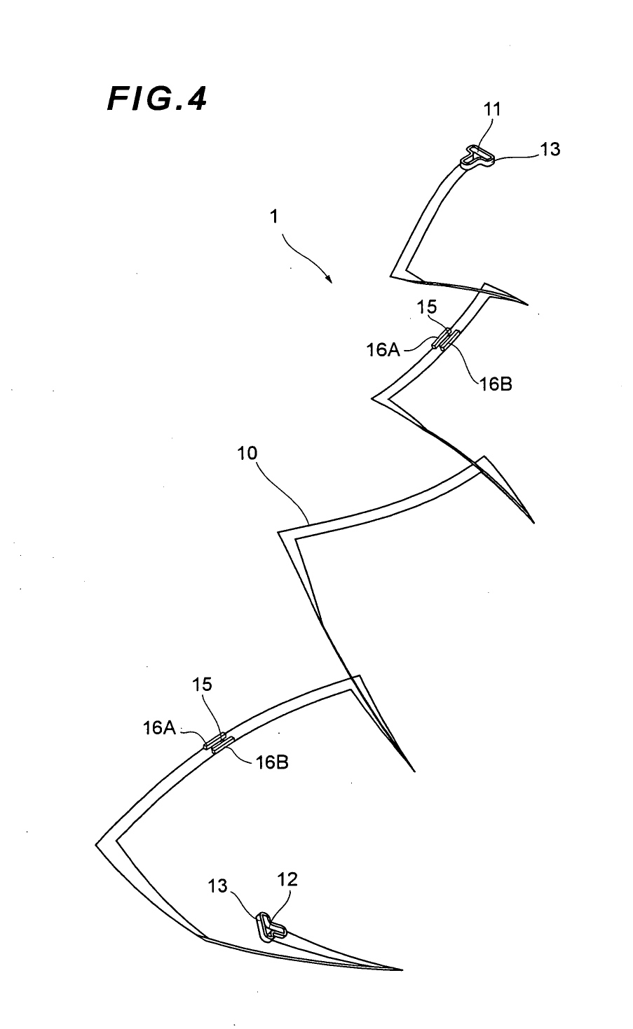

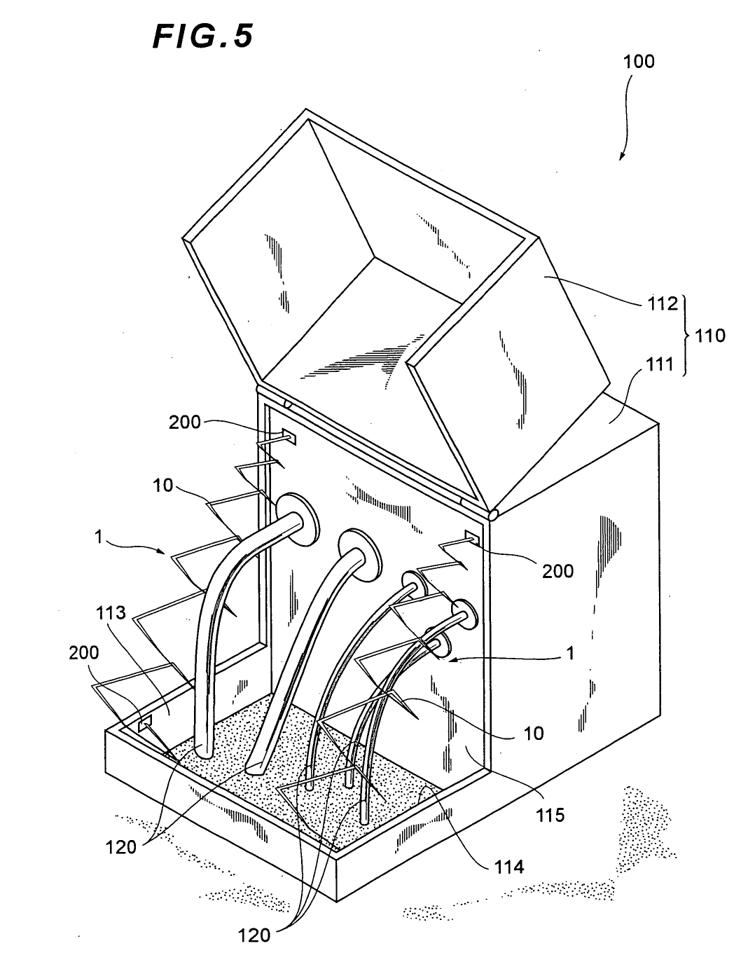

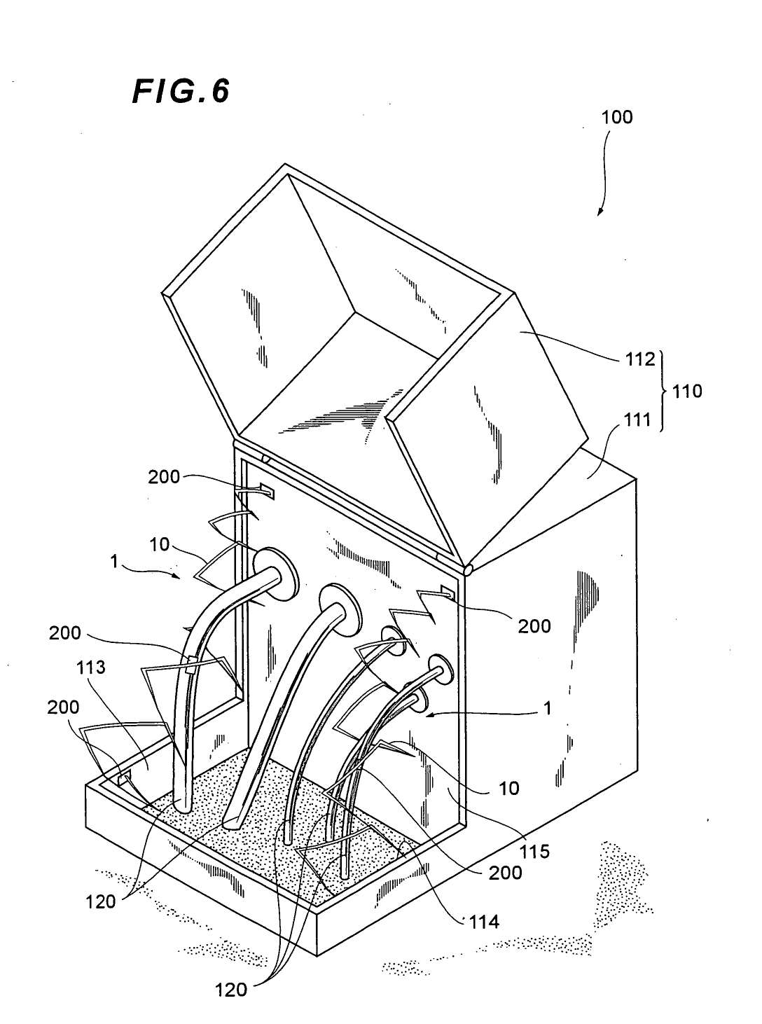

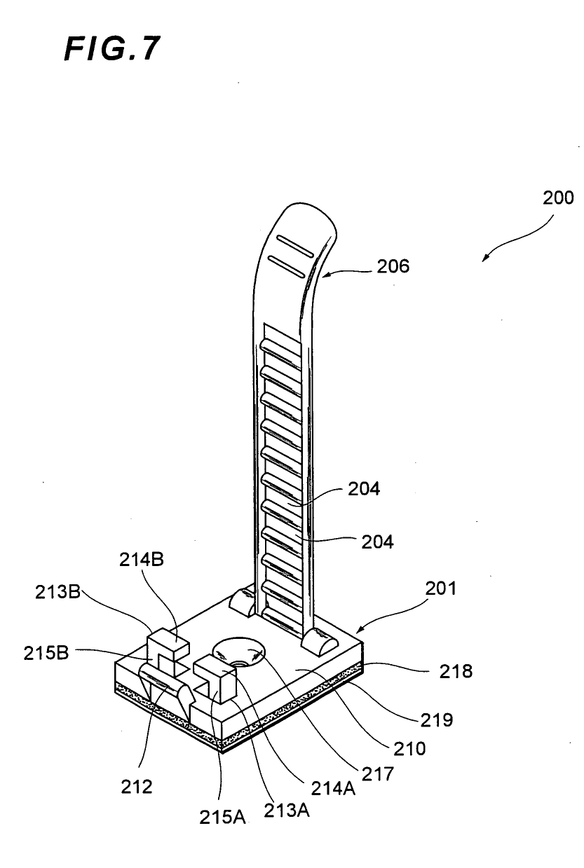

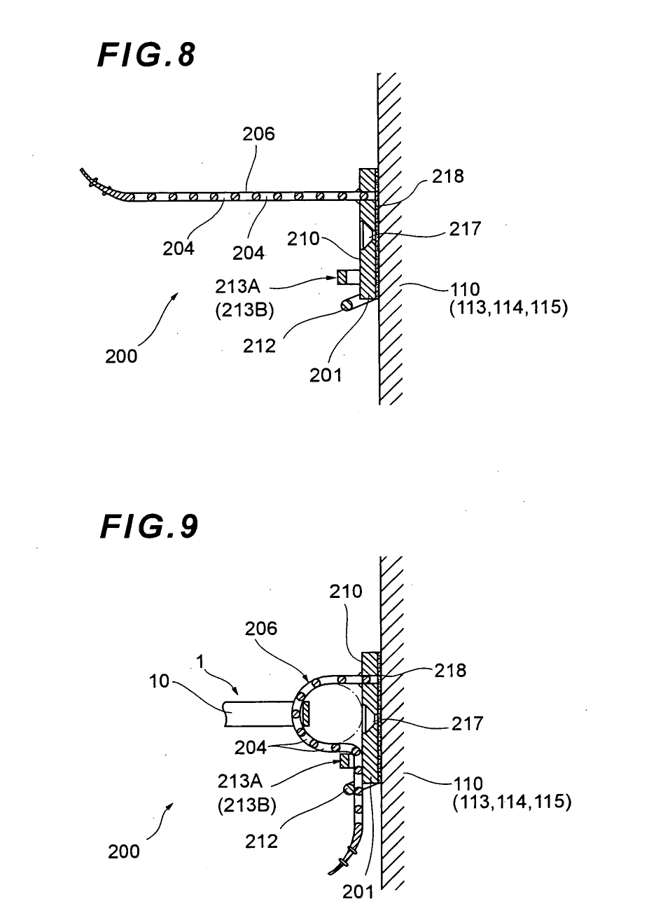

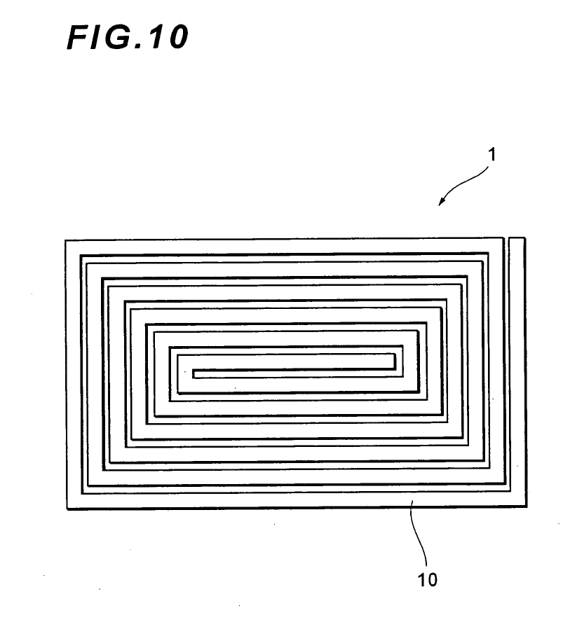

FIG. 1 is a plan view of a pest-control product according to an embodiment of the invention. FIG. 2 is a side view of the pest-control product in FIG. 1 as seen from the direction indicated by arrow X. FIG. 3 is a perspective view of the pest-control product in FIG. 1 in a three-dimensional helix state. FIG. 4 is a perspective view of the pest-control product in FIG. 3 in a more complicated three-dimensional helix state. FIG. 5 is a schematic diagram showing an example of the state where the pest-control product in FIG. 4 is placed inside a transformer. FIG. 6 is a schematic diagram showing another example of the state where the pest-control product in FIG. 4 is placed inside a transformer. FIG. 7 is a perspective view of a fastening device used to place the pest-control product in FIG. 4 inside a transformer. FIG. 8 is a cross-sectional view showing the state where the fastening device in FIG. 7 is secured to the inside wall of a transformer. FIG. 9 is a cross-sectional view showing the fastening device in FIG. 7 in use.

As shown in FIGS. 1 to 9, a pest-control product 1 according to an embodiment of the invention includes a product body 10 configured as one continuous belt member that is made of a resin containing at least either an insect-repelling agent or an insecticide, formed in a plane spiral shape (see FIGS. 1 and 2), that can change its shape to a three-dimensional helix (see FIGS. 3 to 6).

Holes 11 and 12 are made respectively at the ends of the product body 10 so that they can be used to attach the pest-control product 1 to a housing 110 for a transformer 100, which is a target (see FIGS. 5 and 6). A thick part 13 that is thicker than the thickness of the product body 10 is formed around the periphery of each hole 11 and 12. Two holes 15 are also made at certain intervals between the ends of the product body 10 and are used to attach the pest-control product 1 to the housing 110 for the transformer 100. Thick parts 16A and 16B that are thicker than the thickness of the product body 10 are formed around the periphery of the hole 15 and located opposite to each other across the hole 15.

These thick parts 13, 16A, and 16B are formed for the following purpose. When the holes 11, 12, and 15 are made in the product body 10 and the product body 10 has a uniform thickness, a cross-sectional area of the part where each hole 11, 12, and 15 is made, that is taken along the hole depth direction is small. However, the thick parts 13, 16A, and 16B can supplement cross-sectional area shortage. Accordingly, even if the holes 11, 12, and 15 are made in the product body 10, the cross-sectional areas taken along a direction generally parallel with the hole depth direction of the holes in the product body 10 can be made mostly uniform, and the pest-control product 1 can be effective uniformly over the entire pest-control product 1.

The pest-control product 1 maintains its desirable three-dimensional helix (see FIGS. 3 to 6) and is placed in that helical shape inside the housing 110 when it is supported by the inside walls 113 to 116 of the housing 110 for the transformer 100, via a belt part 206 of a fastening device 200 (see FIGS. 7 to 9) secured to the inside walls 113 to 116, by inserting the belt part 206 into the holes 11, 12 and 15 as described later in detail. Even if the volume of the pest-control product 1 itself is small, the pest-control product 1 can cover an extensive area in a three-dimensional space by assuming the preferred shape of the three-dimensional helix. Accordingly, the pest-control product 1 can be effective over an extensive area.

By removing the belt part 206 from the holes 11, 12 and 15, the product body 10 of the pest-control product 1 is released and restores its shape from the three-dimensional helix to the plane spiral shape. Accordingly, the pest-control product 1 is convenient for storage and portable use.

Next, the insect-repelling agent or the insecticide contained in the resin that forms the pest-control product 1 will be explained. The insect-repelling agent or insecticide is a medicinal agent having insect-elimination efficacy. Examples of the insect-repelling agent or insecticide include compounds with insect-repelling efficacy, compounds with insect-killing/harming efficacy, and compounds with insect antifeedant efficacy and insect growth control efficacy.

Specific examples of the insect-repelling agent or insecticide include: pyrethroid compounds; carbamate compounds; organic phosphorous compounds; isomers, derivatives, and analogues of the aforementioned compounds; and other compounds having insect growth control efficacy.

As the resin constituting a component containing the insect-repelling agent or insecticide, at least one type of resin is selected from polyacetal resins and polyamide resins.

It is also preferable that a compound to dissolve and maintain the insect-repelling agent or insecticide in the resin and give controlled-release properties to the resin is contained in the resin. As a compound to dissolve and maintain the insect-repelling agent or insecticide in the resin and give controlled-release properties to the resin, at least one type of compound can be selected from sulfonamide derivatives, sulfonate derivatives, carboxylic acid amide derivates, and carboxylate derivatives.

Inclusion of the compound for providing controlled-release properties in the resin enables the insect-repelling agent or insecticide to be released from the pest-control product 1 over a long period of time. The insect-repelling or killing effect of the pest-control product 1 according to this embodiment can be maintained for about 10 years.

The pest-control product 1 according to this embodiment can be formed by a known molding method such as injection molding.

Next, the configuration of the fastening device 200 for securing the pest-control product 1 to the inside wall of the transformer 100 will be described below.

As shown in FIGS. 7 to 9, the fastening device 200 includes: a base 201; a belt part 206 extending upright from one end of the base 201; an engaging part 212 formed at the other end of a surface 210 of the base 201 for engaging and securing a free end of the belt part 206; and guides 213A and 213B formed close to the end of the surface 210 where the engaging part 212 is located, that guide the free end of the belt part 206.

The base 201 is made of a plate member in a generally rectangular shape as viewed from above. An adhesive layer 218 is formed on the back side of the base 201, and the surface of the adhesive layer 218 is covered with release paper 219. The adhesive layer 218 is exposed by removing the release paper 219, and is then used to secure the fastening device 200 to a desirable target such as the inside wall of the housing 110. A hole 217 is made in the approximate central part of the base 201 so that a pin, a screw or similar can be inserted. The fastening device 200 is secured to, for example, the inside wall of the housing 110 with a pin, a screw or similar inserted into the hole 217 as desired.

The length of the belt part 206 is set as desired and the belt 206 can be bent as shown in FIG. 9. Multiple engaging holes 204 are made in the belt part 206 at desired intervals along the longitudinal direction of the belt part 206.

The engaging part 212 is formed in a hook shape and engages with the engaging hole 204 of the belt part 206, thereby securing the belt part 206.

The guides 213A and 213B are provided with a gap between them and the surface 210 of the base 201 and are respectively formed generally in the shape of the letter L, having parallel surfaces 214A and 214B in parallel with the surface 210, and vertical surfaces 215A and 215B that are connected to and extend generally perpendicularly from the parallel surfaces 214A and 214B and are secured to the surface 210 of the base 201. The guides 213A and 213B are spaced apart from each other and placed symmetrically opposite each other.

Next, a method for placing the pest-control product 1 according to this embodiment inside the housing 110 for the transformer 100 will be described below.

As shown in FIGS. 5 and 6, the transformer 100 is equipped with a plurality of wires 120 in the housing 110. The housing 110 also contains other relevant devices (not shown in the drawings). The housing 110 includes a lower box 111 to be installed on the ground, and a cover 112 provided on the lower box 111.

First, the pest-control product 1 is carried to the transformer 100 to which the pest-control product 1 needs to be attached. Since the pest-control product 1 keeps its plane spiral shape as shown in FIG. 1, the pest-control product 1 is convenient for portable use and compact storage.

The belt part 206 of the fastening device 200 is inserted into each hole 11 and 12 at the ends of the product body 10 of the pest-control product 1. Then, the free end of the belt part 206 is passed through a space between the parallel surfaces 214A and 214B of the guide 213A and 213B and the surface 210 of the base 201 as shown in FIG. 9. Subsequently, any one of the engaging holes 204 in the belt part 206 is made to engage with the engaging part 212 to secure the belt part 206 to the engaging part 212, thereby securing the fastening device 200 to both ends of the product body 10.

Next, as shown in FIG. 5, the fastening device 200 fixed at the hole 11 in the pest-control product 1 is secured to a desired position of the inside wall 113 in the lower part of the lower box 111. The fastening device 200 is easily secured to the inside wall 113 by removing the release paper 219 from the fastening device 200 and pressing the adhesive layer 218 against the inside wall 113. The fastening device 200 may be further firmly secured to the inside wall 113 by inserting a pin, screw or similar into the hole 217 in the fastening device 200.

Then, the fastening device 200 fixed at the hole 12 in the pest-control product 1 is secured to an upper corner of a front wall 115 of the lower box 111 in the same manner as described above. When the pest-control product 1 is attached to the inside wall 113 and the front wall 115 as described above, it changes its shape to a three-dimensional helix, is supported by the inside wall 113 and the upper corner on the front wall 115 of the lower box 111, and thereby stays in a three-dimensional helix.

Another pest-control product 1 is attached to the inside wall 114 opposite the inside wall 113 of the lower box 111 and to the other upper corner of the front wall 115 in the same manner as described above.

By placing the pest-control products 1 inside the housing 110 for the transformer 100 as described above, the pest-control product 1 can be effective over an extensive area and it is possible to prevent pests from entering and nesting in the housing 110.

The fastening devices 200 may also be attached to the holes 15 in the product body 10 of the pest-control product 1, in addition to those attached to the holes 11 and 12. In this case, the fastening devices 200 attached to the holes 15 may be secured to wires 120 as shown in FIG. 6.

This embodiment described the case where the four holes 11, 12, and 15 are made in the product body 10 of the pest-control product 1. However, the configuration of the product body 10 is not limited to this example, and the positions and number of holes to be made in the product body 10 can be decided arbitrarily.

For example, instead of placing one end of the pest-control product 1 at the upper corner of the front wall 115, that end of the pest-control product 1 may be placed on the inside wall of the cover 112. In this case, when the cover 112 is closed, the pest-control product 1 will stay in the housing 110, in a different three-dimensional helix from the three-dimensional helix it forms when the cover 112 is opened.

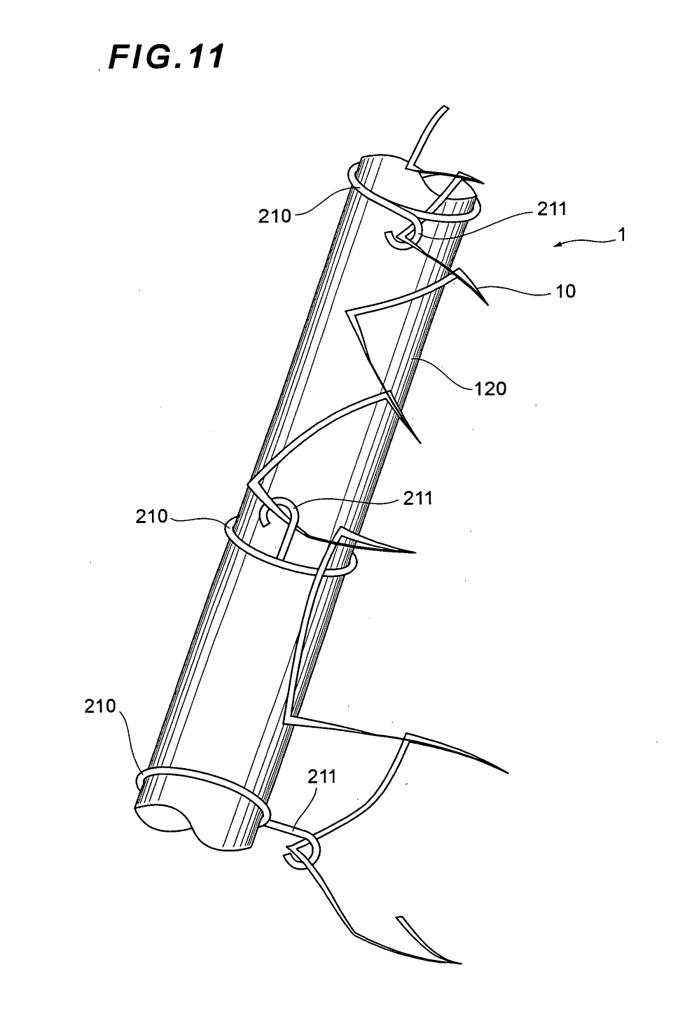

Moreover, this embodiment described the case where the holes are made in the product body 10 as attachment parts to be attached to a target (the housing 110 in this embodiment). However, the attachment parts are not limited to this example, and other forms of attachment parts such as hooks may be formed on the product body 10. Alternatively, no attachment part may be formed as shown in FIG. 10. In this case, for example, a fastening device 210 with a hook may be mounted on a wire 120 as shown in FIG. 11 to attach the pest-control product 1 to the wire 120 by hanging the product body 10 on the hook 211.

Furthermore, this embodiment described the case where the pest-control product 1 is placed inside the housing 110 for the transformer 100. However, the target of the pest-control product 1 is not limited to this example, and it is a matter of course that the pest-control product 1 can be widely used for general targets concerning whatever pest invasion and vermination need to be prevented. Also, the number of the pest-control products 1 to be used can be decided arbitrarily. However, since even if the volume of the pest-control product 1 itself is small, the pest-control product 1 according to the invention can cover an extensive area in a three-dimensional space, and even a number of pest-control products 1 smaller than the number of conventionally-used pest-control products can be sufficiently effective.

Furthermore, according to this embodiment, the length, width, and thickness of the product body 10 of the pest-control product 1 can be decided arbitrarily.

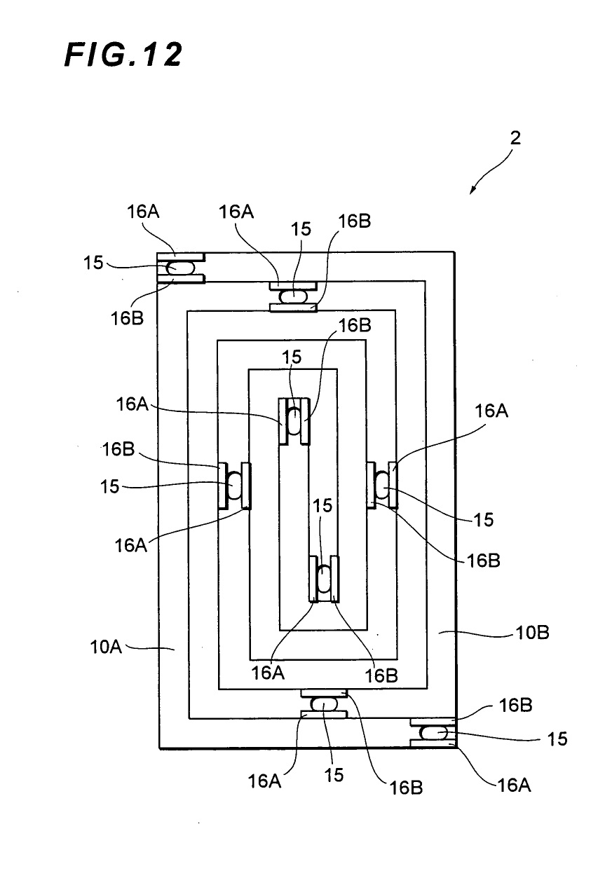

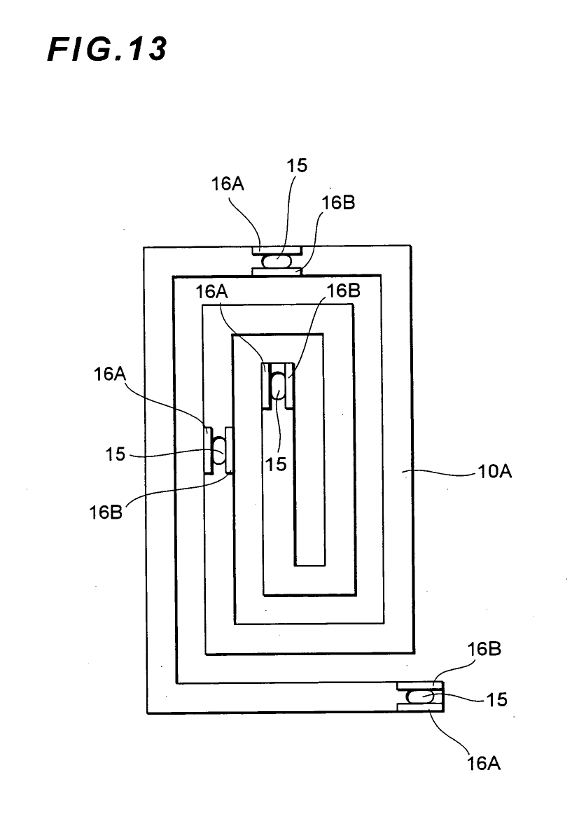

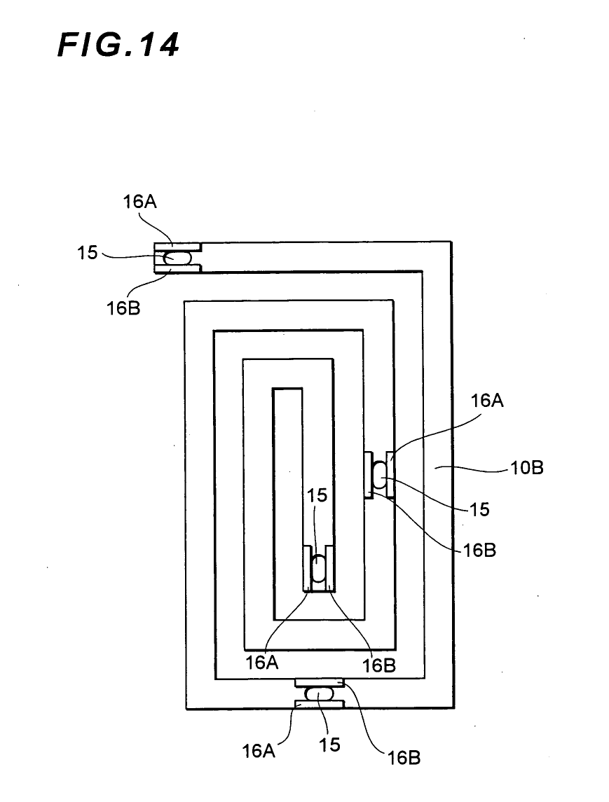

Also, the pest-control product according to the invention may have two product bodies as shown in FIG. 12. Specifically speaking, a pest-control product 2 shown in FIG. 12 includes a product body 10A (see FIGS. 12 and 13) and a product body 10B (see FIGS. 12 and 14) that can respectively keep their plane spiral shapes and change their shapes to three-dimensional helixes. The product bodies 10A and 10B are laid in such a manner that the product body 10B fits in the spiral space defined by the spiral shape of the product body 10A. Since the product bodies 10A and 10B have almost the same shape as that of the product body 10, any detailed description about their shape has been omitted. These product bodies 10A and 10B have a plurality of holes 15 as attachment parts. Thick parts 16A and 16B that are thicker than the thickness of the product bodies 10A and 10B are formed around the periphery of each hole 15 and located opposite to each other across the hole 15.

Since the thick parts 16A and 16B of the product bodies 10A and 10B shown in FIGS. 12 to 14 do not protrude outside the width of the product bodies 10A and 10B, the product bodies 10A and 10B can be combined together as shown in FIG. 12. The pest-control product 2 having this configuration can be easily formed by, for example, punching from one resin sheet containing at least either the insect-repelling agent or the insecticide. The pest-control product 2 can be manufactured economically efficiently without wasting the material. Also, two pest-control products can be stored or carried around in almost the same space as that required for one pest-control product.

What is claimed is:

1. A pest-control product for exterminating pests, comprising a product body made of a resin containing at least either an insect-repelling agent or an insecticide,
wherein the product body is capable of keeping a plane spiral shape and changing its shape to a three-dimensional helix.

2. The pest-control product according to claim 1, wherein the product body is capable of restoring its shape from the three-dimensional helix to the plane spiral shape.

3. The pest-control product according to claim 1 or 2, wherein the product body has at least one attachment part to attach the pest-control product to a target.

4. The pest-control product according to claim 3, wherein the attachment part is a hole made in the product body, and a thick part that is thicker than the thickness of the product body is formed around the periphery of the hole.

5. The pest-control product according to claim 4, wherein the product body is made of one continuous belt member formed in the spiral shape, and
wherein the thickness of the thick part is set so that a cross-section of the belt member taken along a direction generally perpendicular to a longitudinal direction of the belt member is mostly uniform over the entire belt member from its one end to the other end.

6. The pest-control product according to claim 3, wherein the attachment parts are formed at at least both ends of the product body.

7. The pest-control product according to claim 1 or 2, comprising two product bodies,
wherein each product body is made of one continuous belt member, and
wherein when one of the product bodies is in a plane spiral shape, the other product body can be placed in a spiral space defined by the spiral shape.

8. The pest-control product according to claim 7, wherein the spiral shape of the product body is complementary to the spiral space defined by the spiral shape.

9. The pest-control product according to claim 1 or 2, wherein the contour of the product body in the spiral shape is generally quadrangular.
